(19) United States
(12) Patent Application Publication
(10) Pub. No.: US 2014/0092306 A1
(43) Pub. Date: Apr. 3, 2014

(54) APPARATUS AND METHOD FOR RECEIVING ADDITIONAL OBJECT INFORMATION

(71) Applicant: SAMSUNG ELECTRONICS CO., LTD., GYEONGGI-DO (KR)

(72) Inventors: Dong-Hyuk LEE, Seoul (KR); Mu-Sik Kwon, Seoul (KR); Do-Hyeon Kim, Gyeonggi-do (KR); Seong-Taek Hwang, Gyeonggi-do (KR)

(73) Assignee: SAMSUNG ELECTRONICS CO., LTD., GYEONGGI-DO (KR)

(21) Appl. No.: 13/966,955

(22) Filed: Aug. 14, 2013

(30) Foreign Application Priority Data
Sep. 28, 2012 (KR) 10-2012-0109146

(51) Int. Cl. H04N 5/44

(52) U.S. Cl. CPC H04N 5/4403
USPC 348/563

(57) ABSTRACT

An apparatus and a method for receiving additional object information regarding a particular object in at least one frame from among a sequence of a plurality of frames included in image media are provided. The method includes receiving selection of a reference frame including a target object, and receiving selection of the target object in the reference frame; receiving, as an input, additional object information regarding the target object; tracking the target object in each of frames disposed subsequent to the reference frame in the sequence and frames prior to the reference frame in the sequence; extracting target object information from a result of tracking the target object; and building a target object-related information database including at least one of the additional object information regarding the target object and the extracted target object information.

### PRIORITY

This application claims priority under 35 U.S.C. §119(a) to a Korean patent application filed on Sep. 28, 2012 in the Korean Intellectual Property Office and assigned Serial No. 10-2012-0109146, the entire content of which is incorporated herein by reference.

### BACKGROUND OF THE INVENTION

1. Field of the Invention

The present invention relates generally to an apparatus and a method for receiving additional object information on a particular object in a moving image.

2. Description of the Related Art

As usage of smart televisions (i.e., smart TVs) and smart phones has recently increased, the development of services related to smart TVs and smart phones has been actively progressing. Smart TVs and smart phones are not limited to receiving one-way broadcasting, and can bi-directionally transmit information. For example, while a user views images displayed by a smart TV or a smart phone, the user may want to obtain information on one object included the displayed images. Accordingly, the user can operate the smart TV or the smart phone in order to request the information on the one object. In response to the request from the user, the smart TV or the smart phone generates a message for requesting the information, and transmits the generated message to a relevant server. The relevant server transmits the requested information to the smart TV or the smart phone. The smart TV or the smart phone provides the received information to the user. However, according to the above-described scheme, time is required in order to transmit and receive information. Accordingly, the scheme has difficulty in providing information in real time. Particularly, with respect to moving images (i.e., video), the relevant object in a displayed frame may disappear when the displayed frame changes to another frame. Therefore, there is a need for technology, in which the smart TV or the smart phone can receive information on each object together with multiple frames during reception of the multiple frames, and thereby provide information in real time.

In this regard, there is a need for an apparatus and a method for receiving object additional information on a particular object in a moving image.

The above information is presented as background information only to assist with an understanding of the present invention. No assertion is made as to whether any of the above might be applicable as prior art with regard to the present invention.

### SUMMARY OF THE INVENTION

The present invention has been made to address at least the above-mentioned problems and/or disadvantages and to provide at least the advantages described below. Accordingly, an aspect of the present invention is to provide an apparatus and a method for receiving object additional information on a particular object in a moving image.

In accordance with an aspect of the present invention, a method for receiving additional object information regarding a particular object in at least one frame from among a sequence of a plurality of frames included in image media is provided. The method includes receiving selection of a reference frame including a target object, and receiving selection of the target object in the reference frame; receiving, as an input, additional object information regarding the target object; tracking the target object in each of frames disposed subsequent to the reference frame in the sequence and frames prior to the reference frame in the sequence; extracting target object information from a result of tracking the target object; and building a target object-related information database including at least one of the additional object information regarding the target object and the extracted target object information.

In accordance with another aspect of the present invention, an apparatus that receives additional object information regarding a particular object in at least one frame from among a sequence of a plurality of frames included in image media is provided. The apparatus includes a display unit that displays the at least one frame; an input unit that receives selection of a reference frame including a target object and selection of the target object in the reference frame, and receives, as an input, additional object information on the target object; and a controller that tracks the target object in each of frames disposed subsequent to the reference frame in the sequence and frames prior to the reference frame in the sequence, extracts target object information from a result of tracking the target object, and builds a target object-related information database including at least one of the additional object information regarding the target object and the extracted target object information.

In accordance with another aspect of the present invention, a method for providing additional object information regarding a target object in at least one frame from among a sequence of a plurality of frames included in image media data is provided. The method includes receiving a target object-related information database comprising at least one of the image media data, the additional object information regarding the target object, and extracted target object information extracted from the target object; displaying a plurality of the frames included the image media data; receiving, as an input, a request for the additional object information regarding the target object displayed in at least one of the plurality of frames; comparing the request for the additional object information regarding the target object with the target object-related information database; and providing the additional information according to a result of the comparison.

In accordance with another aspect of the present invention, an apparatus that provides additional object information regarding a target object in at least one frame from among a sequence of a plurality of frames included in image media data is provided. The apparatus includes a storage unit that stores a target object-related information database comprising at least one of the image media data, the additional object information regarding the target object, and extracted target object information extracted from the target object; a display unit that displays a plurality of the frames included in the image media data; an input unit that receives, as an input, a request for the additional object information regarding the target object displayed in at least one of the plurality of frames; and a controller that performs a control operation for comparing the request for the additional object information regarding the target object with the target object-related information database, and providing the additional information according to a result of the comparison.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram schematically illustrating a configuration of a mobile apparatus according to an embodiment of the present invention;

FIG. 2 is a perspective view of a mobile device according to an embodiment of the present invention;

FIG. 3 is a flowchart illustrating a method for receiving object additional information on an object in a moving image according to an embodiment of the present invention;

FIGS. 4A to 4D are conceptual diagrams illustrating a method for receiving object additional information on an object in a moving image according to an embodiment of the present invention;

FIG. 5 is a conceptual diagram illustrating a structure of a target object-related information database (DB) according to an embodiment of the present invention;

FIG. 6 is a flowchart illustrating a method for providing additional information by a consumer-side device according to an embodiment of the present invention; and

FIGS. 7A and 7B are conceptual diagrams illustrating a method for providing additional information in a consumer-side device according to an embodiment of the present invention.

Throughout the drawings, it should be noted that like reference numbers are used to depict the same or similar elements, features, and structures.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as mere examples. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the dictionary meanings, but are merely used to enable a clear and consistent understanding of the invention. Accordingly, the following description of embodiments of the present invention is provided for illustration purposes and does not limit the scope of the invention as defined by the appended claims and their equivalents.

Herein, the singular forms “a,” “an,” and “the” include plural referents unless the context clearly dictates otherwise. Thus, for example, reference to “a component surface” includes reference to one or more of such surfaces.

Although the terms including ordinal numbers such as first and second may be used herein to describe various elements, these elements should not be limited by these terms. These terms are only used to distinguish one element from another. For example, a first element could be termed a second element, and similarly, a second element could be termed a first element, without departing from the scope of right of the present invention. The terminology used herein is for the purpose of describing particular embodiments of the present invention, and does not limit the scope of the present invention. As used herein, the term “and/or” includes any and all combinations of one or more of the associated listed items.

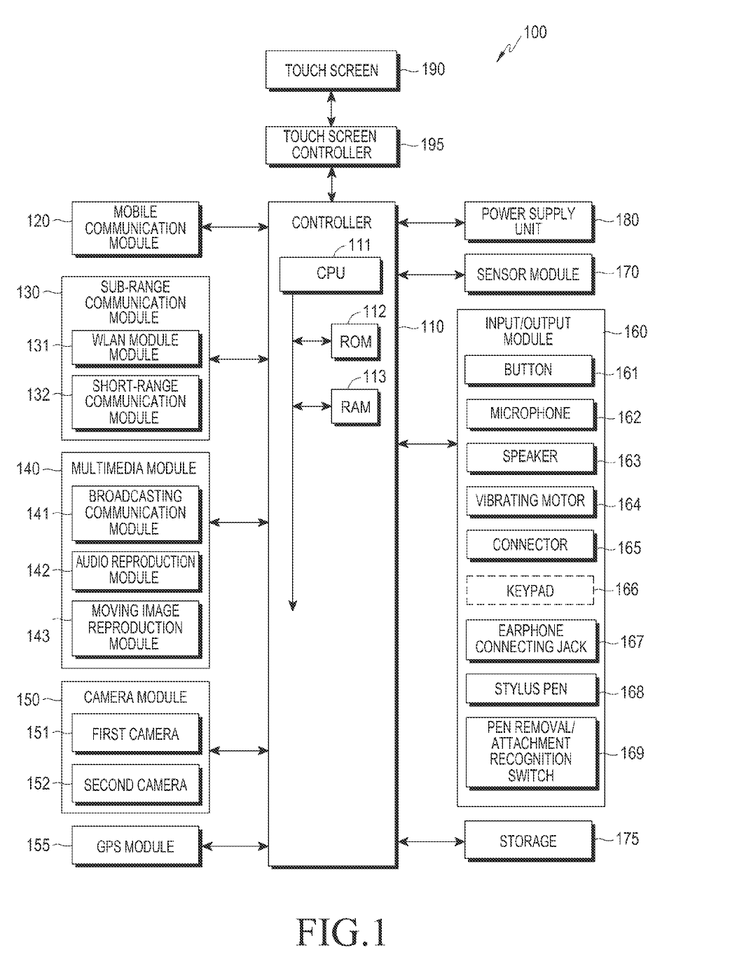

FIG. 1 is a block diagram schematically illustrating a configuration of a mobile device according to an embodiment of the present invention.

Referring to FIG. 1, the mobile device 100 includes a controller 110, a mobile communication module 120, a sub-range communication module 130, a multimedia module 140, a camera module 150, a Global Positioning System (GPS) module 155, an input/output module 160, a sensor module 170, a storage unit 175, and a power supply unit 180, a touch screen 190, and a touch screen controller 195.

According to embodiments of the present invention, the mobile device 100 may be connected to an external device (not shown) by using the mobile communication module 120, a sub-range communication module 130 and a connector 165. The external devices include another device (not shown), a mobile phone (not shown), a smart phone (not shown), a tablet PC (not shown), and a server (not shown).

According to an embodiment of the present invention, the sub-range communication module 130 includes at least one of a wireless Local Area Network (LAN) module 131 and a short-range communication module 132 (e.g., a Near-Field Communication (NFC) communication module). For example, the sub-communication module 130 may include one or both of the wireless LAN module 131 and short-range communication module 132.

According to an embodiment of the present invention, the multimedia module 140 includes at least one of a broadcasting communication module 141, an audio reproduction module 142, and a moving image reproduction module 143.

According to an embodiment of the present invention, the camera module 150 may include at least one of a first camera 151 and a second camera 152.

According to an embodiment of the present invention, the input/output module 160 includes at least one of buttons 161, a microphone 162, a speaker 163, a vibration motor 164, the connector 165 and a keypad 166. The input/output module 160 may include an earphone jack 167, a stylus pen 168, a pen removal/attachment recognition switch 169, etc.

The controller 110 may include a Central Processing Unit (CPU) 111, a Read-Only Memory (ROM) 112 that stores a control program for controlling the mobile device 100, and a Random Access Memory (RAM) 113 that stores a signal or data received from the outside of the mobile device 100, or is used as a memory area for a task performed by the mobile device 100. The CPU 111 may include multiple processors. For example, the CPU 111 may include a single-core processor, a dual-core processor, a triple-core processor, a quad-core processor, etc. The CPU 111, the ROM 112 and the RAM 113 may be interconnected by an internal bus.

The controller 110 controls the mobile communication module 120, the sub-communication module 130, the multimedia module 140, the camera module 150, the GPS module 155, the input/output module 160, the sensor module 170, the storage unit 175, the power supply unit 180, a first touch screen 190a, a second touch screen 190b, and the touch screen controller 195.

According to the control of the controller 110, the mobile communication module 120 allows the mobile device 100 to be connected to an external device through mobile communication by using at least one antenna or multiple antennas (not shown). The mobile communication module 120 transmits and receives wireless signals for voice calls, video calls, Short Message Service (SMS) messages, Multimedia Messaging Service (MMS) messages, etc. to/from a mobile phone (not shown), a smart phone (not shown), a tablet PC or another device (not shown), which has a telephone number input to the mobile device 100.

According to the control of the controller 110, the wireless LAN module 131 may be connected to the Internet at a place where a wireless Access Point (AP) (not shown) is installed. The wireless LAN module 131 supports a wireless LAN standard (e.g., IEEE 802.11x of the Institute of Electrical and Electronics Engineers (IEEE)). According to the control of the controller 110, the short-range communication module 132 enables the mobile device 100 to perform short-range wireless communication with an image forming device (not shown). Short-range communication schemes may include Bluetooth, Infrared Data Association (IrDA), and the like.

According to varying embodiments of the present invention, the mobile device 100, the mobile device 100 may include at least one of the mobile communication module 120, the wireless LAN module 131 and the short-range communication module 132, or any combination thereof.

The multimedia module 140 may include the broadcasting communication module 141, the audio reproduction module 142, and/or a moving image reproduction module 143. According to the control of the controller 110, the broadcasting communication module 141 receives a broadcast signal (e.g., a TV broadcast signal, a radio broadcast signal, a data broadcast signal, etc.) and additional broadcast information (e.g., an Electronic Program Guide (EPG) or an Electronic Service Guide (ESG)), which are transmitted by a broadcast station through a broadcast communication antenna (not shown). According to the control of the controller 110, the audio reproduction module 142 reproduces stored or received digital audio files (e.g., a file having a file extension of mp3, wma, ogg, or way). According to the control of the controller 110, the moving image reproduction module 143 reproduces stored or received digital moving image files (e.g., a file having a file extension of mpeg, mpg, mp4, avi, mov, or mkv). The moving image reproduction module 143 may also reproduce digital audio files.

According to an embodiment of the present invention, the multimedia module 140 may include the audio reproduction module 142 and the moving image reproduction module 143, without including the broadcasting communication module 141. According to another embodiment of the present invention, the audio reproduction module 142 or the moving image reproduction module 143 of the multimedia module 140 may be included in the controller 110.

The camera module 150 includes at least one of the first camera 151 and the second camera 152, each for capturing a still image or a moving image according to the control of the controller 110. Also, the first camera 151 or the second camera 152 may include an auxiliary light source, such as a flash (not shown), which provides additional light to be used when capturing an image. The first camera 151 may be mounted on a front surface of the mobile device 100, and the second camera 152 may be mounted on a rear surface of the mobile device 100. Otherwise, the first camera 151 and the second camera 152 may be disposed adjacent to each other (e.g., a distance between the first camera 151 and the second camera 152 may be greater than 1 cm and is less than 8 cm), and, in such a configuration, the first camera 151 and the second camera 152 may capture a three-dimensional still image or a three-dimensional moving image.

The GPS module 155 receives a signal (e.g., a radio wave) from each of multiple GPS satellites (not shown) in the Earth's orbit, and calculates a location of the mobile device 100 by using a Time of Arrival (TOA) from each of the GPS satellites (not shown) to the mobile device 100.

The input/output module 160 includes at least one input/output device, such as at least one of the multiple buttons 161, the microphone 162, the speaker 163, the vibration motor 164, the connector 165 and the keypad 166.

The buttons 161 may be formed on a front surface, a lateral surface or a rear surface of a housing of the mobile device 100, and may include at least one of a power/lock button (not shown), a volume button (not shown), a menu button, a home button, a back button and a search button.

According to the control of the controller 110, the microphone 162 receives a voice or sound as input, and generates an electrical signal according to the received input.

According to the control of the controller 110, the speaker 163 outputs sounds matched to various signals (e.g., a wireless signal, a broadcast signal, a digital audio file, a digital moving image file, and photographing) from the mobile communication module 120, the sub-communication module 130, the multimedia module 140 and the camera module 150, to the outside of the mobile device 100. The speaker 163 may output a sound (e.g., a button operation sound or a ring back tone matched to a telephone call) matched to a function that the mobile device 100 performs. The display apparatus 100 may include multiple speakers. The speaker 163 or multiple speakers may be disposed at an appropriate position or appropriate positions of the housing of the mobile device 100 for directing output sounds

According to the control of the controller 110, the vibration motor 164 converts an electrical signal into a mechanical vibration. For example, when the mobile device 100 in a vibration mode receives a voice call from another device (not shown), the vibration motor 164 of the mobile device 100 may operate. The display apparatus 100 may include multiple vibration motors. The vibration motor 164 or multiple vibration motors may be mounted within the housing of the mobile device 100. The vibration motor 164 may operate in response to a touch action of a user who touches the touch screen 190 and a continuous movement of a touch on the touch screen 190.

The connector 165 is used as an interface for connecting the mobile device 100 to an external device (not shown) or a power source (not shown). According to the control of the controller 110, through a wired cable connected to the connector 165, the mobile device 100 transmits data stored in the storage unit 175 of the mobile device 100 to an external device (not shown) and/or receives data from the external device (not shown). Also, through the wired cable connected to the connector 165, the mobile device 100 may be supplied with power from the power source (not shown) or may charge a battery (not shown) by using the power source.

The keypad 166 receives key input from the user in order to control the mobile device 100. The keypad 166 includes a physical keypad (not shown) installed on the front surface of the mobile device 100 and/or a virtual keypad (not shown) displayed on the touch screen 190. According to an embodiment of the present invention, the physical keypad (not shown) installed on the front surface of the mobile device 100 may be omitted.

The sensor module 170 includes at least one sensor for detecting the state of the mobile device 100. For example, the sensor module 170 may include a proximity sensor for detecting whether the user is close to the mobile device 100, an illuminance sensor (not shown) for detecting the amount of light around the mobile device 100, a motion sensor (not shown) for detecting the motion of the mobile device 100 (e.g., the rotation of the mobile device 100, or acceleration or vibration applied to the mobile device 100), and the like. At least one sensor may detect the state of the mobile device 100, may generate a signal matched to the detection, and may transmit the generated signal to the controller 110. According to the performance of the mobile device 100, sensors may be added to or removed from the sensor module 170.

According to the control of the controller 110, the storage unit 175 may store a signal or data which is input/output in response to an operation of each of the mobile communication module 120, the sub-communication module 130, the multimedia module 140, the camera module 150, the GPS module 155, the input/output module 160, the sensor module 170, and the touch screen 190. The storage unit 175 may store a control program for controlling the mobile device 100 or a control program for the controller 110, and applications.

The term “storage unit” may refer to any one of or a combination of the storage unit 175, the ROM 112 and the RAM 113 within the controller 110, or a memory card (not shown), such as a Secure Digital (SD) card or a memory stick, which is mounted on the mobile device 100, for example. The storage unit may include a non-volatile memory, a volatile memory, a Hard Disk Drive (HDD), a Solid State Drive (SSD), etc.

According to the control of the controller 110, the power supply unit 180 may supply power to one battery or multiple batteries (not shown) disposed in the housing of the mobile device 100. The one battery or the multiple batteries (not shown) supply power to the mobile device 100. Also, the power supply unit 180 may supply power provided by an external power source (not shown) to the mobile device 100 through a wired cable connected to the connector 165.

The touch screen 190 provides the user with a user interface matched to various services (e.g., telephone call, data transmission, broadcasting, and photography). The touch screen 190 transmits an analog signal matched to at least one touch, which is input to the user interface, to the touch screen controller 195. The touch screen 190 may receive at least one touch as input from the user's body (e.g., fingers, thumbs, and the like) or an input means (e.g., a stylus pen) enabling a touch. Also, the touch screen 190 may receive, as input, a continuous movement of one touch with respect to at least one touch. The touch screen 190 may transmit an analog signal matched to a continuous movement of an input touch, to the touch screen controller 195.

According to embodiments of the present invention, a touch is not limited to the touch of the user's body or the input means enabling a touch on the touch screen 190, but may include a non-contact touch (e.g., a detectable distance between the touch screen 190 and the user's body or the input means enabling a touch is less than or equal to 1 mm). In the touch screen 190, a detectable distance may change depending on the performance or structure of the mobile device 100.

The touch screen 190, for example, may be implemented as a resistive touch screen, a capacitive touch screen, an infrared touch screen, a surface acoustic wave touch screen, etc.

The touch screen controller 195 converts an analog signal received from the touch screen 190 into a digital signal (e.g., X and Y coordinates), and provides the digital signal to the controller 110. The controller 110 controls the touch screen 190 by using the digital signal received from the touch screen controller 195. For example, in response to a touch, the controller 110 may control the touch screen 190 to select or execute a shortcut icon (not shown) displayed on the touch screen 190. According to an embodiment of the present invention, the touch screen controller 195 may be included in the controller 110.

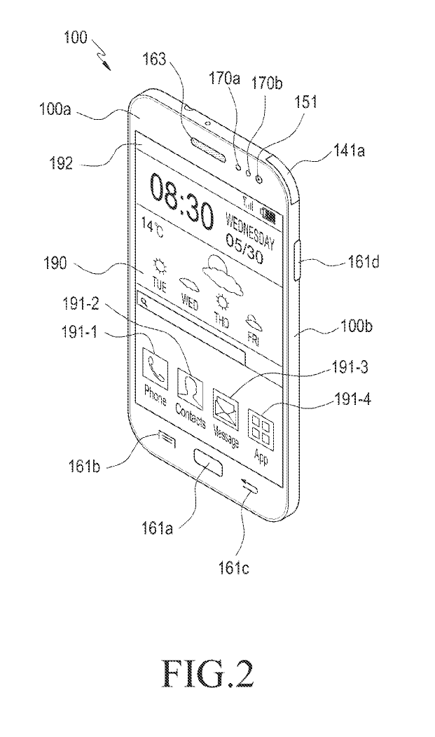

FIG. 2 is a perspective view of a mobile device according to an embodiment of the present invention. Referring to FIG. 2, the touch screen 190 is disposed in the center of a front surface 100a of the mobile device 100. The touch screen 190 is largely formed so as to occupy most of the front surface 100a of the mobile device 100. The first camera 151, an illuminance sensor 170a, and a proximity sensor 170b may be disposed at the edge of the front surface 100a of the mobile device 100. Also, a home button 161a, a menu button 161b and a back button 161c may be disposed the front surface 100a of the mobile device 100. The home button 161a is used to display the main home screen on the touch screen 190. For example, if the home button 161a is touched while any home screen different from the main home screen or a menu screen is displayed on the touch screen 190, then the main home screen may be displayed on the touch screen 190. If the home button 161a is touched while applications are executed on the touch screen 190, the main home screen shown in FIG. 2 may be displayed on the touch screen 190. The home button 161a may be used to display the recently used applications or a task manager on the touch screen 190. The menu button 161b provides connection menus that can be used on the touch screen 190. The connection menus may include a widget add menu, a background screen change menu, a search menu, an edit menu, a settings menu, and the like. The back button 161c may be used to display the screen that was displayed just before the screen that is currently displayed, or may be used to terminate the most recently used application.

On a lateral surface 100b of the mobile device 100, for example, a power/reset button 160a, a speaker phone button 161d, a speaker 163, a terrestrial Digital Multimedia Broadcasting (DMB) antenna 141a for receiving broadcast signals, a microphone (not shown), a connector (not shown) and the like may be disposed. The second camera 152 (not shown) may be disposed on a rear surface (not shown) of the mobile device 100.

The bottom bar is lengthily elongated in a horizontal direction at a lower end part of the touch screen 190, and includes standard function buttons 191-1 to 191-4. A home button 161a is used to display the home screen on the main screen. For example, when the home button 161a is touched while applications are executed on the main screen, the home screen illustrated in FIG. 2 is displayed on the main screen. A back button 161c is used to display a screen that has been executed just before a screen that is currently being executed, or is used to terminate most recently used application.

Also, a top bar 192, which displays the states of the mobile device 100, such as the state of battery charging, the strength of a received signal, current time, and the like, is formed in an upper end part of the touch screen 190.

Meanwhile, the applications are programs that are independently implemented by a manufacturer of the mobile device 100 and/or application developers. Accordingly, the execution of one application does not necessarily require another application to be executed in advance. Also, when the execution of one application is completed, another application may still be continuously executed.

The above-described applications are programs that are independently implemented, and thus are distinguished from multi-functional applications obtained by adding some functions (e.g., a memo function, and a function of transmitting and receiving a message), which another application provides, to one application (e.g., a moving image application). However, such a multi-functional application is a single application that is newly made in order to have various functions, and differs from the existing applications. Accordingly, the multi-functional application may not provide various functions as in the case of the existing applications, and provides limited functions. Moreover, a user has the burden of separately purchasing such a new multi-functional application.

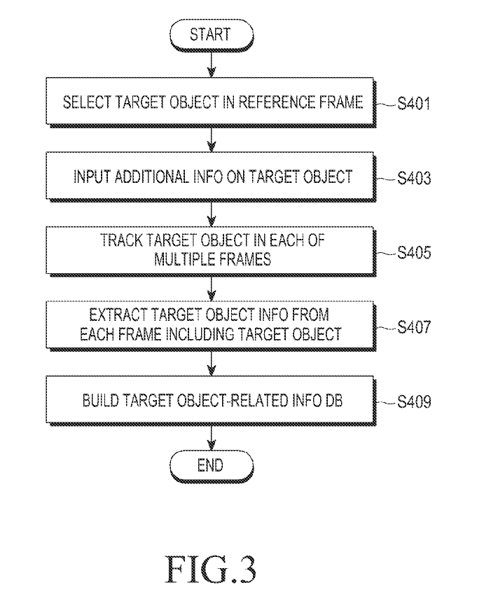

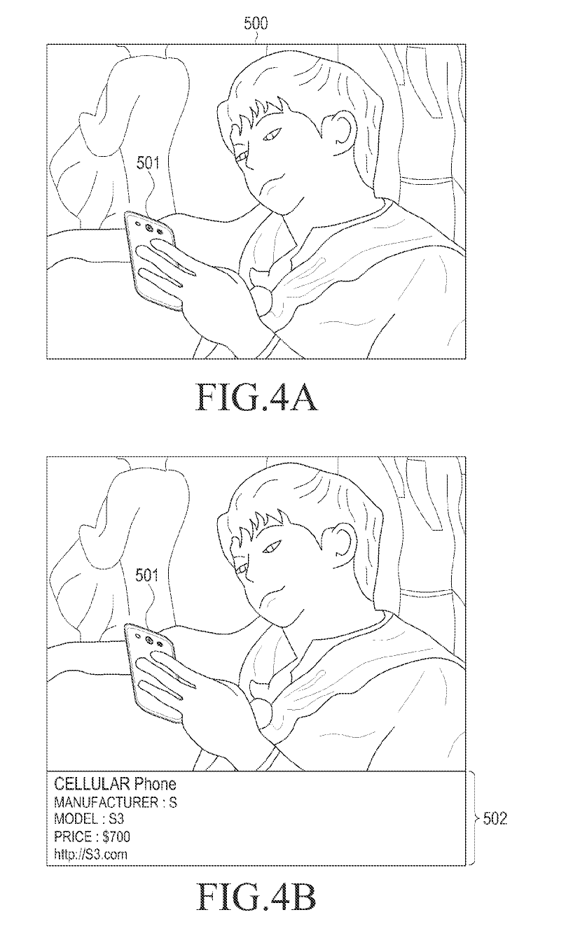

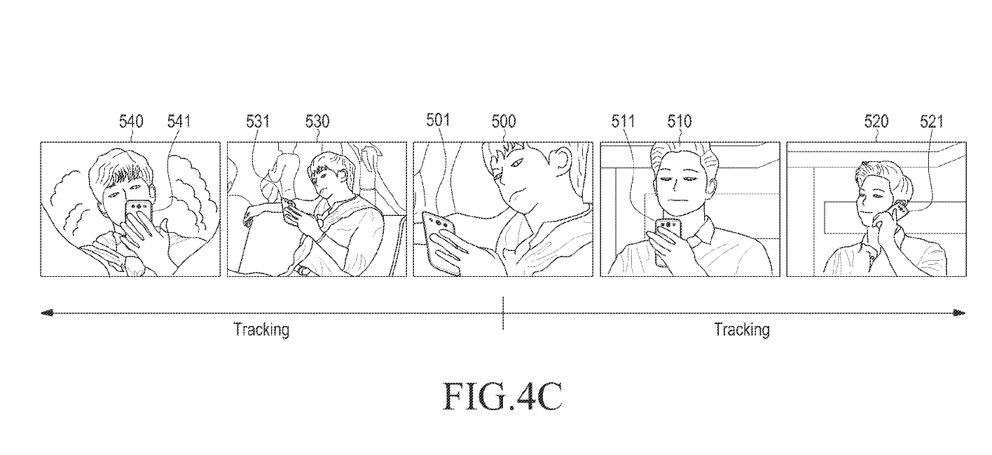

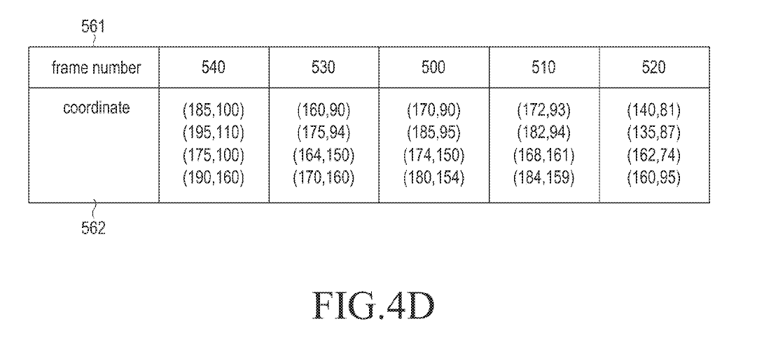

FIG. 3 is a flowchart illustrating a method for receiving object additional information on an object in a moving image according to an embodiment of the present invention. The method illustrated in FIG. 3 will be described with reference to FIGS. 4A to 4D.

A user who inputs additional information selects one reference frame from among multiple frames configuring a moving image. The user who inputs additional information selects a frame including an object on which additional information is to be input, from among multiple frames. For example, the user who inputs additional information may select a frame 500 illustrated in FIG. 4A, from among multiple frames configuring a moving image. In the present example, the user who inputs additional information intends to input additional information on a smart phone 501 in the frame 500 illustrated in FIG. 4A. Accordingly, the user who inputs additional information selects the frame 500 including the smart phone 501, as a reference frame, from among multiple frames included in the moving image.

Also, the user who inputs additional information designates an object, on which additional information is to be input, in the reference frame 500, in step S401. In the present example, the user who inputs additional information designates a part of the reference frame 500 at which the smart phone 501 is displayed. Hereinafter, an object that becomes a target on which additional information is input, is referred to as a “target object.” Meanwhile, an apparatus for receiving additional information may include a display unit for displaying a frame and an input unit capable of receiving an input.

When the target object has been designated in step S401, the user who inputs additional information inputs additional information on the target object, in step S403. For example, the user who inputs additional information inputs additional information 502 on the smart phone 501, as illustrated in FIG. 4B. Here, the additional information 502 on the target object may include at least one of product type information, product manufacturer information, model information, price information, homepage information of the relevant manufacturer, a hyperlink, and a tag. For example, the apparatus for receiving additional information may include an input unit. The user who inputs additional information operates the input unit, and inputs additional information to the apparatus for receiving additional information.

When the input of the additional information has been completed in step S403, the apparatus for receiving additional information tracks the target object in each of frames preceding and following the reference frame, in step S405. For example, the apparatus for receiving additional information tracks the target object in each of frames 510, 520, 530 and 540 preceding and following the reference frame 500, as illustrated in FIG. 4C. The apparatus for receiving additional information detects a position and/or feature points of each of target objects 511, 521, 531 and 541, respectively, in the frames 510, 520, 530 and 540 preceding and following the reference frame 500. The operations as described above, for example, may be performed by a controller of the apparatus for receiving additional information.

The apparatus for receiving additional information may track a target object by using a tracking method according to the related art. The apparatus for receiving additional information extracts information of each of the tracked objects 511, 521, 531 and 541, in step S407. The apparatus for receiving additional information extracts pixel coordinate information and/or feature points of each of the tracked objects 511, 521, 531 and 541.

When the apparatus for receiving additional information extracts the pixel coordinate information of each of the tracked objects 511, 521, 531 and 541, the apparatus for receiving additional information stores an identification number and the extracted pixel coordinate information of the relevant frame together. FIG. 4D is a conceptual view diagram illustrating a format for storing extracted information according to an embodiment of the present invention. Referring to FIG. 4D, the apparatus for receiving additional information stores a frame identification number 561 and pixel coordinate information 562 together in a storage unit. For example, the apparatus for receiving additional information may store pixel coordinate information such that a target object is included in an area defined by (180,100), (195,110), (175,160) and (190,168) in a frame 540. The apparatus for receiving additional information may store pixel coordinate information of a target object in each of frames 530, 500, 510 and 520.

Meanwhile, when the apparatus for receiving additional information extracts feature points of each of the tracked objects 511, 521, 531 and 541, the apparatus for receiving additional information stores the relevant image and the feature point information together. Here, the feature points may be an edge, a corner, a blob, etc. The apparatus for receiving additional information stores an image of a target object and multiple pieces of feature point information matched to the target object together.

As described above, the apparatus for receiving additional information may first track the target object, and thereby extracts information on the target object. In the process as described above, the apparatus for receiving additional information is capable of storing a frame identification number and pixel coordinate information of a target object, or an image of the target object and feature point information thereof. However, according to embodiments of the present invention, the apparatus for receiving additional information may also have a modified configuration for storing all of the frame identification number, the pixel coordinate information of the target object, the image of the target object, and the feature point information thereof.

The apparatus for receiving additional information builds a target object-related information DB including at least one of the target object, the received additional information on the target object, the tracking information, and the information on the tracked target object, in step S409. The apparatus for receiving additional information provides the built target object-related information DB to content consumers. For example, the apparatus for receiving additional information may separately provide the related information DB to content consumers, or may provide the related information DB to the content consumers together with multiple frames included in a moving image.

Meanwhile, the user who inputs additional information may repeat the process as described above with respect to another object as well as the particular object. Accordingly, the apparatus for receiving additional information may generate and store a target object-related information DB including information related to multiple objects.

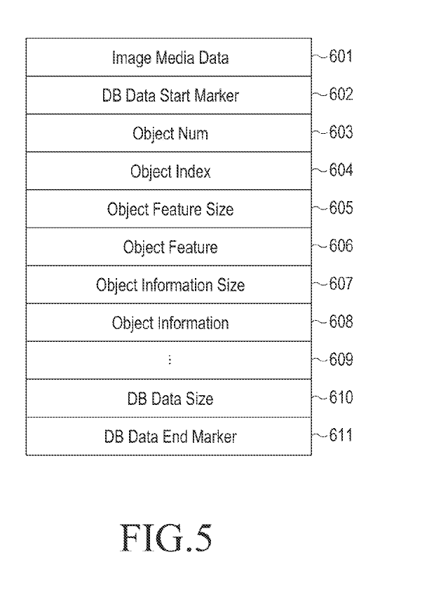

FIG. 5 is a diagram illustrating a structure of a target object-related information database (DB) according to an embodiment of the present invention. An embodiment of the present invention as illustrated in FIG. 5 includes a configuration in which the target object-related information DB is constructed together with image media data. Specifically, in the example according to FIG. 5, the apparatus for receiving additional information generates structured data including the image media data and the target object-related information DB.

First, the apparatus for receiving additional information stores image media data 601. For example, the apparatus for receiving additional information may include image media data encoded in a predetermined scheme. The apparatus for receiving additional information may include image media data encoded in a scheme, such as a Moving Picture Experts Group (MPEG)-7 encoding scheme. However, this configuration is described for illustrative purposes only. Accordingly, there is no restriction on schemes for encoding the image media data 601 in accordance with embodiments of the present invention.

The apparatus for receiving additional information stores a DB data start marker 602 indicating a start point of the target object-related information DB. The DB data start marker 602, which is inserted in order to distinguish the image media data 601 from the target object-related information DB, indicates a start time point of the target object-related information DB.

The apparatus for receiving additional information stores information 603 on the number of target objects on each of which additional information has been input. The information 603 on the number of target objects indicates the number of target objects designated by the user who inputs additional information.

The apparatus for receiving additional information stores an identification number 604 of each target object. For example, when the number of target objects is equal to 4, the apparatus for receiving additional information may assign identification numbers of 0001, 0010, 0011 and 0100 to a first target object, a second target object, a third target object and a fourth target object, respectively. In an area named the identification number 604 of each target object, the assign identification numbers may be recorded.

The apparatus for receiving additional information stores information 605 indicating size of extracted information of each target object. Based on the information 605 indicating the size of extracted information of each target object, a consumer-side device may recognize up to which position an area, in which information that the consumer-side device must use is stored, is located in the target object-related information DB.

The apparatus for receiving additional information stores extracted information 606 of each target object. The extracted information 606 of each target object may include a frame including each target object and pixel coordinate information of each target object, or an image of each target object and feature point information thereof.

The apparatus for receiving additional information stores information 607 indicating a size of additional information on each target object. Based indicating the information 607 on the size of additional information on each target object, the consumer-side device may recognize up to which position an area, in which information that the consumer-side device must use is stored, is located in the target object-related information DB.

The apparatus for receiving additional information stores additional information 608 on each target object. The additional information 608 on each target object may include at least one of product type information, product manufacturer information, model information, price information, homepage information of the relevant manufacturer, a hyperlink and a tag, which the user who inputs additional information has input.

Meanwhile, the apparatus for receiving additional information further stores information 609 on other target objects. For example, the apparatus for receiving additional information may further store a target object identification number of each of other target objects, information on the size of extracted information of each of other target objects, the extracted information of each of other target objects, information on the size of additional information on each of other target objects additional, and the additional information on each of other target objects.

The apparatus for receiving additional information further stores information 610 indicating a size of the target object-related information DB and an end marker 611 indicating the completion of the target object-related information DB.

The apparatus for receiving additional information transmits the generated image media data 601 and the target object-related information DB 602 to 611 together to the consumer-side device.

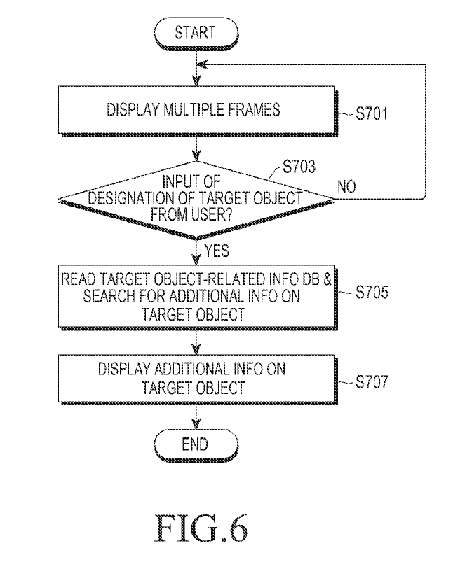

FIG. 6 is a flowchart illustrating a method for providing additional information by a consumer-side device according to an embodiment of the present invention.

The consumer-side device may receive image media data and a target object-related information DB from the apparatus for receiving additional information.

Referring to FIG. 6, in response to an operation by a consumer, the consumer-side device displays multiple frames in step S701. For example, the consumer-side device may include a display unit such as a touch screen or a Liquid Crystal Display (LCD), and may display multiple frames of the received image media data.

While the consumer is viewing the image media data, the consumer may view a target object on which additional information is to be obtained. The consumer-side device determines whether the designation of a target object has been input from a user, in step S703. Specifically, the consumer-side device receives, as input, a request for additional information on the target object.

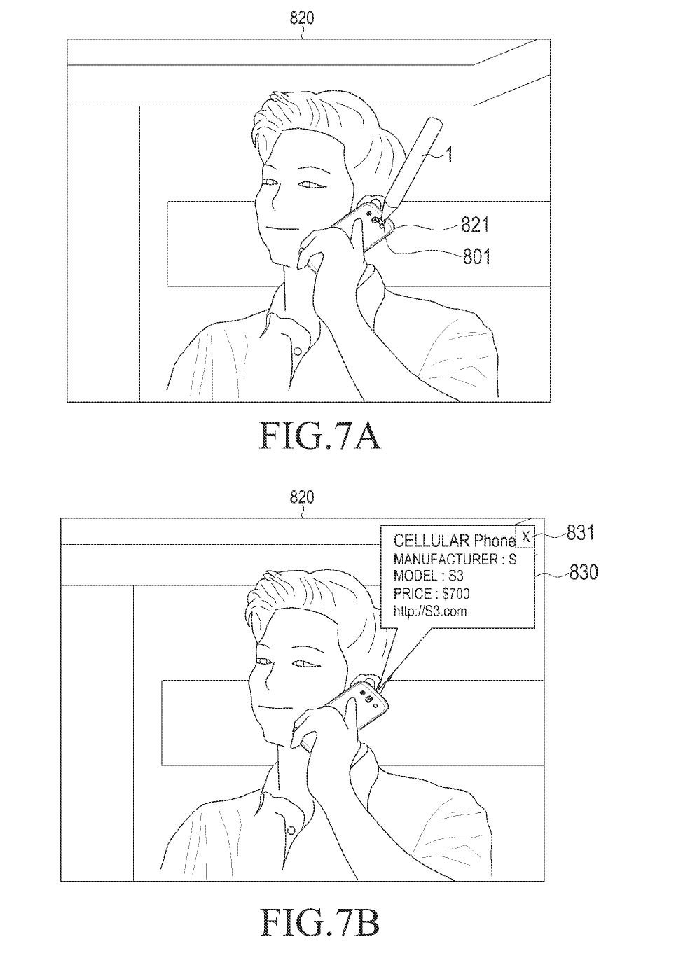

For example, as illustrated in FIG. 7A, the consumer designates a target object 821, on which additional information is to be obtained, in a particular frame 820. The consumer touches the target object by using a pen 1 or a finger of the consumer (not shown), as denoted by reference numeral 801. When the target object 821 has been designated by the consumer (Yes from step S703), the consumer-side device reads the target object-related information DB stored in a storage unit and searches for additional information on the target object that has been input from the consumer, in step S705. For example, a controller of the consumer-side device reads the target object-related information DB stored in the storage unit of the consumer-side device, and searches for the additional information on the target object.

For example, the controller analyzes the input designation of the target object from the consumer, and compares the analyzed input of the designation of the target object with the target object-related information DB. Specifically, when the target object-related information DB is stored as a frame including the target object and pixel coordinates of the target object, the consumer-side device identifies pixel coordinates of the input of the designation of the target object. The consumer-side device determines whether the identified pixel coordinates of the input of the designation of the target object are included in an area defined by pixel coordinates of the target object in the relevant frame. When a result of the determination shows that the identified pixel coordinates of the input of the designation of the target object are included in the area defined by the pixel coordinates of the target object in the relevant frame, the consumer-side device provides additional information regarding the relevant target object. Also, when the target object-related information DB includes an image of the target object and feature points thereof, the consumer-side device may analyze the input designation of the target object, and extract the image of the target object. The consumer-side device may provide the corresponding additional information based on the extracted image.

As an alternative, the consumer-side device may perform image tracking in a front direction and in a rear direction of the extracted image based on the image extracted from the input of the designation of the target object. Herein, the front direction refers from earlier frame to later frame and the rear direction refers opposite direction to the front direction. The consumer-side device, for example, may perform the image tracking, and thereby may provide additional information matched to feature points of an image stored in the target object-related information DB.

Meanwhile, upon determining that the designation of the target object has not been input from the user in step S703, the operation returns to step S701, such that the consumer-side device may continuously display the multiple frames.

The consumer-side device displays additional information regarding the searched target object, in step S707. For example, as illustrated in FIG. 7B, the consumer-side device may display additional information 830 on the target object in such a manner as to cause the additional information 830 to overlap the frame 820. The additional information 830 may include an end function key 831 enabling the consumer to terminate display of the additional information 830. Meanwhile, this configuration is described for illustrative purposes only. Accordingly, the consumer-side device may display the additional information on the target object in a different scheme.

It will be appreciated that the embodiments of the present invention may be implemented in the form of hardware, software, or a combination thereof. Any such software may be stored in a volatile or non-volatile storage device such as a Read-Only Memory (ROM), or in a memory such as a Random Access Memory (RAM), a memory chip, a memory device or a memory integrated circuit, or in a storage medium, such as a Compact Disc (CD), a Digital Versatile Disc (DVD), a magnetic disk or a magnetic tape, which is optically or magnetically recordable and simultaneously, is readable by a machine (e.g., a computer), regardless of whether the software can be deleted or rewritten. It will be appreciated that the method for receiving object additional information according to embodiments of the present invention may be implemented by a computer or a portable terminal including a controller and a memory, and that the memory is an example of a non-transient machine-readable storage medium suitable for storing a program or programs including instructions for implementing the embodiments of the present invention. Accordingly, embodiments of the present invention may include a program including codes for implementing an apparatus or a method which is claimed in any claim of this specification, and a storage medium which stores this program and is readable by a machine (e.g., a computer).

Also, an apparatus for receiving object additional information according to embodiments of the present invention may receive and store the program from a device for providing a program, which is connected to the mobile device by a wire or wirelessly. A device for providing a program according to embodiments of the present invention may include a memory for storing a program including instructions which cause the apparatus for receiving object additional information to perform a previously-set method for receiving object additional information, information required for the method for receiving object additional information, and the like; a communication unit for performing wired or wireless communication with the mobile device; and a controller for performing a control operation so as to transmit the relevant program to the apparatus for receiving object additional information, at a request from the apparatus for receiving object additional information or automatically.

The apparatus and the method for receiving object additional information according to various embodiments of the present invention, enable receipt of object additional information on a particular object in a moving image. A smart TV or a smart phone may store simultaneously multiple pieces of additional information on objects in each frame as well as in each moving image frame. Accordingly, when a user requests information on a particular object, additional information is provided in real time. Particularly, even when a frame changes at a high speed, such as when viewing moving images, the user can easily acquire the additional information.

While the invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for receiving additional object information regarding a particular object in at least one frame from among a sequence of a plurality of frames included in image media, the method comprising:
receiving selection of a reference frame including a target object, and receiving selection of the target object in the reference frame;
receiving, as an input, additional object information regarding the target object;
tracking the target object in each of frames disposed subsequent to the reference frame in the sequence and frames prior to the reference frame in the sequence;
extracting target object information from a result of tracking the target object; and
building a target object-related information database including at least one of the additional object information regarding the target object and the extracted target object information.

2. The method as claimed in claim 1, further comprising generating structured data obtained by structurizing image media data of the image media and the target object-related information database.

3. The method as claimed in claim 2, wherein the structured data comprises at least one of:
a start marker indicating a start point of the target object-related information database;
information indicating a total number of target objects included in the target object-related information database;
an identification number of each target object included in the target object-related information database;
additional object information regarding each target object included in the target object-related information database;
information indicating a size of the additional object information regarding each of the target objects included in the target object-related information database;
extracted information extracted from each the target object included in the target object-related information database;
information indicating a size of the extracted information of each target object included in the target object-related information database;
information indicating a size of the target object-related information database; and
an end marker indicating completion of the target object-related information database.

4. The method as claimed in claim 1, wherein extracting the target object information from the result of tracking the target object comprises extracting pixel coordinate information of the tracked target object and a frame identification number of each frame including the tracked target object.

5. The method as claimed in claim 4, wherein the pixel coordinate information of the tracked target object corresponds to pixel coordinates of four vertexes of the tracked target object.

6. The method as claimed in claim 1, wherein extracting the target object information from the result of tracking the target object comprises extracting an image and feature points of the tracked target object.

7. The method as claimed in claim 6, wherein the extracted feature points correspond to an edge, a corner, or a blob.

8. An apparatus that receives additional object information regarding a particular object in at least one frame from among a sequence of a plurality of frames included in image media, the apparatus comprising:
a display unit that displays the at least one frame;
an input unit that receives selection of a reference frame including a target object and selection of the target object in the reference frame, and receives, as an input, additional object information on the target object; and
a controller that tracks the target object in each of frames disposed subsequent to the reference frame in the sequence and frames prior to the reference frame in the sequence, extracts target object information from a result of tracking the target object, and builds a target object-related information database including at least one of the additional object information regarding the target object and the extracted target object information.

9. The apparatus as claimed in claim 8, wherein the controller generates structured data obtained by structurizing image media data of the image media and the target object-related information database.

10. The apparatus as claimed in claim 9, wherein the structured data comprises at least one of:
a start marker indicating a start point of the target object-related information database;
information indicating a total number of target objects included in the target object-related information database;
an identification number of each target object included in the target object-related information database;
additional object information on each target object included in the target object-related information database;
information indicating a size of the additional object information regarding each target object included in the target object-related information database;
extracted information of each target object included in the target object-related information database;
information indicating a size of the extracted information of each target object included in the target object-related information database;
information indicating a size of the target object-related information database; and
an end marker indicating completion of the target object-related information database.

11. The apparatus as claimed in claim 8, wherein the controller extracts pixel coordinate information of the tracked target object and a frame identification number of each frame including the tracked target object.

12. The apparatus as claimed in claim 11, wherein the pixel coordinate information of the tracked target object corresponds to pixel coordinates of four vertexes of the tracked target object.

13. The apparatus as claimed in claim 8, wherein the controller extracts an image and feature points of the tracked target object.

14. The apparatus as claimed in claim 13, wherein the extracted feature points correspond to an edge, a corner, or a blob.

15. A method for providing additional object information regarding a target object in at least one frame from among a sequence of a plurality of frames included in image media data, the method comprising:
receiving a target object-related information database comprising at least one of the image media data, the additional object information regarding the target object, and extracted target object information extracted from the target object;
displaying a plurality of the frames included the image media data;
receiving, as an input, a request for the additional object information regarding the target object displayed in at least one of the plurality of frames;
comparing the request for the additional object information regarding the target object with the target object-related information database; and
providing the additional information according to a result of the comparison.

16. The method as claimed in claim 15, wherein the receiving of the target object-related information database comprising the at least one of the image media data, the additional object information regarding the target object, and the extracted target object information comprises receiving structured data obtained by structurizing the image media data of the image media and the target object-related information database.

17. The method as claimed in claim 16, wherein the structured data comprises at least one of:
a start marker indicating a start point of the target object-related information database;
information indicating a total number of target objects included in the target object-related information database;
an identification number of each target object included in the target object-related information database;
additional object information regarding each target object included in the target object-related information database;
information indicating a size of the additional object information regarding each target object included in the target object-related information database;
extracted information extracted from each target object included in the target object-related information database;
information indicating a size of the extracted information of each target object included in the target object-related information database;
information indicating a size of the target object-related information database; and
an end marker indicating completion of the target object-related information database.

18. The method as claimed in claim 15, wherein the extracted target object information includes pixel coordinate information of a tracked target object and a frame identification number of each frame including the tracked target object.

19. The method as claimed in claim 18, wherein the pixel coordinate information of the tracked target object corresponds to pixel coordinates of four vertexes of the tracked target object.

20. The method as claimed in claim 19, wherein a request for the additional object information regarding the target object corresponds to an input for designating an object included in each frame, and
wherein comparing the request for the additional object information regarding the target object with the target object-related information database includes determining whether pixel coordinates of the designated object are included in an area defined by the four vertexes of the tracked target object.

21. The method as claimed in claim 15, wherein the extracted target object information corresponds to an extracted image and extracted feature points of a tracked target object.

22. The method as claimed in claim 21, wherein the extracted feature points correspond to an edge, a corner, or a blob.

23. The method as claimed in claim 21, wherein a request for the additional object information regarding the target object corresponds to an input for designating an object included in each frame, and
wherein the comparing of the request for the additional object information regarding the target object with the target object-related information database comprises comparing the designated object with the extracted image of the tracked target object.

24. The method as claimed in claim 23, wherein the comparing of the request for the additional object information regarding the target object with the target object-related information database comprises:
tracking the designated object; and
comparing the tracked designated object with the extracted image of the tracked target object.

25. An apparatus that provides additional object information regarding a target object in at least one frame from among a sequence of a plurality of frames included in image media data, the apparatus comprising:
a storage unit that stores a target object-related information database comprising at least one of the image media data, the additional object information regarding the target object, and extracted target object information extracted from the target object;
a display unit that displays a plurality of the frames included in the image media data;
an input unit that receives, as an input, a request for the additional object information regarding the target object displayed in at least one of the plurality of frames; and
a controller that performs a control operation for comparing the request for the additional object information regarding the target object with the target object-related information database, and providing the additional information according to a result of the comparison.

26. The apparatus as claimed in claim 25, wherein the storage unit stores data obtained by structurizing the image media data of the image media and the target object-related information database.

27. The apparatus as claimed in claim 26, wherein the structured data comprises at least one of:
a start marker indicating a start point of the target object-related information database;
information indicating a total number of target objects included in the target object-related information database;
an identification number of each target object included in the target object-related information database;
additional object information regarding each target object included in the target object-related information database;
information indicating a size of the additional object information regarding each target object included in the target object-related information database;
extracted information extracted from each target object included in the target object-related information database;
information indicating a size of the extracted information of each target object included in the target object-related information database;
information indicating a size of the target object-related information database; and
an end marker indicating completion of the target object-related information database.

28. The apparatus as claimed in claim 25, wherein the extracted target object information includes pixel coordinate information of a tracked target object and a frame identification number of each frame including the tracked target object.

29. The apparatus as claimed in claim 28, wherein the pixel coordinate information of the tracked target object corresponds to pixel coordinates of four vertexes of the tracked target object.

30. The apparatus as claimed in claim 29, wherein a request for the additional object information regarding the target object corresponds to an input for designating an object included in each frame, and
wherein the controller determines whether pixel coordinates of the designated object are included in an area defined by the four vertexes of the tracked target object.

31. The apparatus as claimed in claim 25, wherein the extracted target object information corresponds to an extracted image and extracted feature points of a tracked target object.

32. The apparatus as claimed in claim 31, wherein the extracted feature points correspond to an edge, a corner, or a blob.

33. The apparatus as claimed in claim 31, wherein a request for the additional object information regarding the target object corresponds to an input for designating an object included in each frame, and
wherein the controller performs a control operation for comparing the designated object with the extracted image of the tracked target object.

34. The apparatus as claimed in claim 33, wherein the controller performs a control operation for tracking the designated object and comparing the tracked designated object with the extracted image of the tracked target object.
